(19) United States
(12) Patent Application Publication
(10) Pub. No.: US 2010/0303362 A1
(43) Pub. Date: Dec. 2, 2010

(54) Image Data Processing Methods

(75) Inventors: Wonsun Kim, Suwon-si (KR); Doohoon Goo, Hwaseong-si (KR); Byeongok Cho, Seoul (KR); Changmin Park, Hwaseong-si (KR); Soonnam Kang, Hwaseong-si (KR); Jeongho Yeo, Suwon-si (KR)

Correspondence Address: MYERS BIGEL SIBLEY & SAJOVEC, PO BOX 37428, RALEIGH, NC, 27627, US

(73) Assignee: Samsung Electronics Co., Ltd.

(21) Appl. No.: 12/774,778

(22) Filed: May 6, 2010

(30) Foreign Application Priority Data
Jun. 1, 2009 (KR) 2009-0048205

(51) Int. Cl. G06K 9/48

(52) U.S. Cl. 382/199

(57) ABSTRACT

Provided are image data processing methods. Such methods include obtaining image data with at least one bar pattern, detecting coordinates of an edge of the bar pattern, extracting an outline curve of the bar pattern by fitting the coordinates of the edge, setting a direction of a major axis by differentiating the outline curve of the bar pattern, rotating the image data to match the major axis with a reference axis, and extracting information of the bar pattern by processing the bar pattern of the rotated image data.

### CROSS-REFERENCE TO RELATED APPLICATIONS

This U.S. non-provisional patent application claims priority under 35 U.S.C. § 119 of Korean Patent Application No. 10-2009-0048205, filed on Jun. 1, 2009, the entire contents of which are hereby incorporated by reference as if set forth fully herein.

### BACKGROUND

The present disclosure herein relates to processing devices and methods and, more particularly, to image data processing devices and methods.

A critical dimension scanning electron microscope (CDSEM) measures the dimension of a pattern. A line width measuring method of a pattern of image data, provided from the CDSEM may be performed by obtaining image data of a substrate using the CDSEM. The image data may include a plurality of bar patterns. In order to measure a major/minor axis line width of the bar pattern, the image data may rotate the bar pattern with a predetermined rotation angle inputted by a user. Accordingly, the major axis of the bar pattern of the image data may be vertically disposed. A profile of the bar pattern may be read. Coordinates at the edge of the bar pattern may be detected from the profile. The coordinates of the edge may calculate the dimension of the bar pattern using a critical dimension (CD) measurement algorithm.

### SUMMARY

The present disclosure provides image data processing methods using a rotation angle automatic compensation algorithm.

The present disclosure also provides image data processing devices using a rotation angle automatic compensation algorithm.

The present disclosure also provides a computer readable recording medium including a rotation angle automatic compensation algorithm.

Embodiments of the present invention provide image data processing methods including obtaining image data that includes at least one bar pattern and detecting coordinates of an edge of the at least one bar pattern. An outline curve of the bar pattern is extracted by fitting the coordinates of the edge and a direction of a major axis is set by differentiating the outline curve of the bar pattern, and rotating the image data to match the major axis with a reference axis. Information of the bar pattern is extracted by processing the bar pattern of the rotated image data.

Some embodiments provide that detecting the coordinates of the edge of the bar pattern includes setting a coordinate axis of the image data, extracting the coordinates of the edge of the bar pattern from the image data, and setting the curve portions as target regions after dividing the bar pattern into straight line portions and curve portions using the coordinates of the edge of the bar pattern. In some embodiments, extracting an outline curve of the bar pattern by fitting the coordinates of the edge includes extracting an outline curve of the bar pattern by fitting the coordinates of the edge only in the target regions.

Some embodiments provide that setting the direction of the major axis by differentiating the outline curve of the bar pattern and rotating the image data to match the major axis with the reference axis include determining the major axis by connecting points where a differential sign is changed by differentiating the outline curve. A major axis angle between the major axis and the reference axis is calculated and the image data is rotated corresponding to the major axis angle. Some embodiments include confirming whether the major axis angle is within a predetermined error range or not.

In some embodiments, setting the direction of the major axis by differentiating the outline curve of the bar pattern and rotating the image data to match the major axis with the reference axis include setting the major axis using the highest point and the lowest point of the outline curve of the bar pattern.

Some embodiments provide that the information of the bar pattern includes a line width of the bar pattern or an interval between the bar patterns.

In some embodiments, the operations described herein may be repeated to provide an iterative process for processing image data.

It is noted that aspects of the invention described with respect to one embodiment, may be incorporated in a different embodiment although not specifically described relative thereto. That is, all embodiments and/or features of any embodiment can be combined in any way and/or combination. These and other objects and/or aspects of the present invention are explained in detail in the specification set forth below.

### BRIEF DESCRIPTION OF THE DRAWINGS

The accompanying figures are included to provide a further understanding of the present invention, and are incorporated in and constitute a part of this specification. The drawings illustrate some embodiments of the present invention and, together with the description, serve to explain principles of the present invention.

FIGS. 1 and 2 are flowcharts illustrating methods of processing image data with a bar pattern according to some embodiments of the present invention.

FIG. 3 is a view illustrating an image data processing device according to some embodiments of the present invention.

FIGS. 4A through 4E are views illustrating image data processing methods according to some embodiments of the present invention.

### DETAILED DESCRIPTION OF THE EMBODIMENTS

The present invention now will be described more fully hereinafter with reference to the accompanying drawings, in which embodiments of the invention are shown. However, this invention should not be construed as limited to the embodiments set forth herein. Rather, these embodiments are provided so that this disclosure will be thorough and complete, and will fully convey the scope of the invention to those skilled in the art.

It will be understood that, although the terms first, second, etc. may be used herein to describe various elements, these elements should not be limited by these terms. These terms are only used to distinguish one element from another element. Thus, a first element discussed below could be termed a second element without departing from the scope of the present invention. In addition, as used herein, the singular forms “a”, “an” and “the” are intended to include the plural forms as well, unless the context clearly indicates otherwise. It also will be understood that, as used herein, the term “comprising” or “comprises” is open-ended, and includes one or more stated elements, steps and/or functions without precluding one or more unstated elements, steps and/or functions. The term “and/or” includes any and all combinations of one or more of the associated listed items.

It will also be understood that when an element is referred to as being “connected” to another element, it can be directly connected to the other element or intervening elements may be present. In contrast, when an element is referred to as being “directly connected” to another element, there are no intervening elements present. It will also be understood that the sizes and relative orientations of the illustrated elements are not shown to scale, and in some instances they have been exaggerated for purposes of explanation. Like numbers refer to like elements throughout.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and this specification and will not be interpreted in an idealized or overly formal sense unless expressly so defined herein. The present invention will now be described more fully hereinafter with reference to the accompanying drawings, in which preferred embodiments of the invention are shown. This invention, however, may be embodied in many different forms and should not be construed as limited to the embodiments set forth herein. Rather, these embodiments are provided so that this disclosure will be thorough and complete, and will fully convey the scope of the invention to those skilled in the art.

It should be construed that forgoing general illustrations and following detailed descriptions are exemplified and an additional explanation of claimed inventions is provided.

Reference numerals are indicated in detail in some embodiments of the present invention, and their examples are represented in reference drawings. Throughout the drawings, like reference numerals are used for referring to the same or similar elements in the description and drawings.

Image data processing methods according to some embodiments of the invention may process image data of each substrate with a bar pattern and may automatically set up a rotation angle of the bar pattern. Accordingly, the image data processing methods may provide an accurate line width measurement of the bar pattern. Some embodiments provide that determining a direction of a major axis of the bar pattern may be accomplished through at least one differentiation of an outline curve of the bar pattern.

The image data processing methods described herein may not necessarily match a direction of a pattern to be measured with a scan direction of an electron beam. Additionally, the image data processing methods may use a verified line width measurement algorithm and thus can provide consistent date with traditional data.

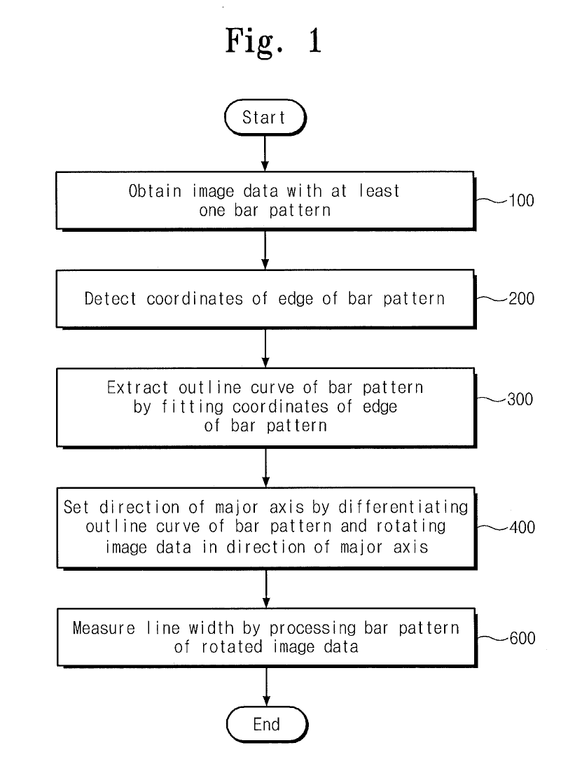

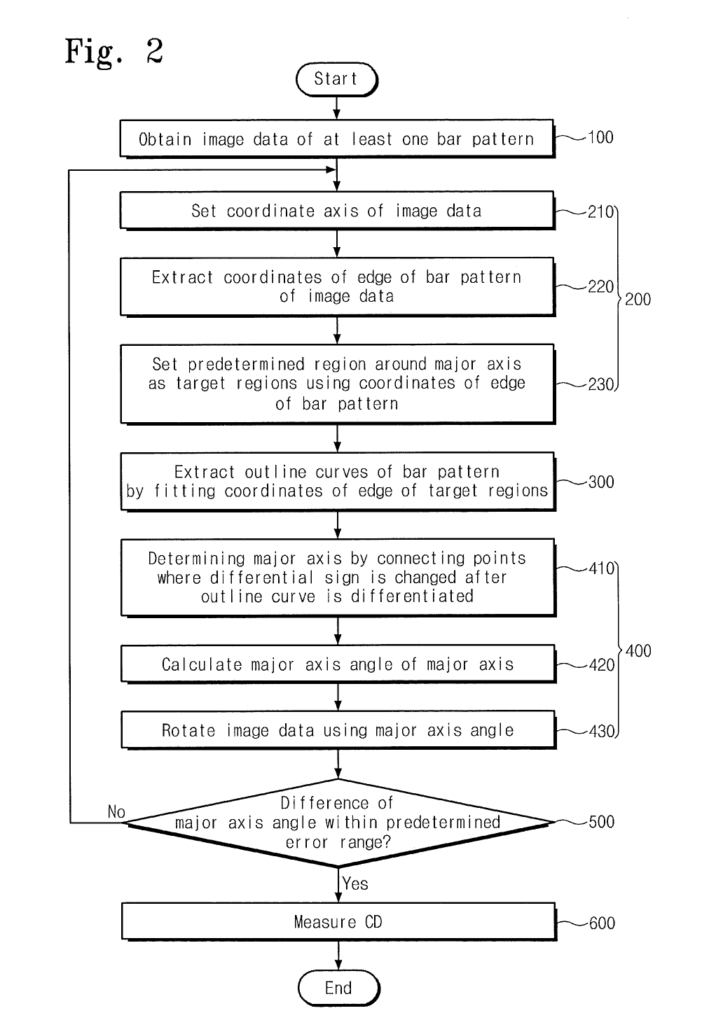

Reference is now made to FIGS. 1 and 2, which are flowcharts illustrating methods of processing image data with a bar pattern according to some embodiments of the present invention. Embodiments of image data processing methods may include obtaining image data with at least one bar pattern (block 100). Coordinates of the edge of the bar pattern may be detected (block 200) and an outline curve of the bar pattern may be extracted by fitting the coordinates of the edge (block 300). A direction of a major axis of the bar pattern may be set by differentiating the outline curve of the bar pattern and rotating the image data to match the direction of the major axis with a reference axis (block 400). A line width may be measured by processing the bar pattern of the rotated image data (block 600).

The image data may include at least one bar pattern. The bar pattern may form a curved loop. The bar pattern may be a rectangular form or an oval form. The bar pattern may be slanted with respect to the reference axis. Some embodiments provide that the bar pattern may be a photoresist pattern of a photolithography process and/or an etching pattern of an etching process. In some embodiments, the image data may be 512×512 pixels or more, however, the invention is not so limited. Some embodiments provide that the image data may be a gray scale.

Referring to FIG. 2, detecting coordinates of the edge of the bar pattern (block 200) may include setting a coordinate axis of the image data (block 210), extracting the coordinates of the edge of the bar pattern of the image data (block 220), and setting at least one predetermined target region around the major axis as, for example, two target regions using the coordinates of the edge of the bar pattern (block 230).

Some embodiments provide that the coordinate axis of the image data (block 210) may be set arbitrarily. In some embodiments, the coordinate axis may be an axis of an orthogonal coordinate system. Some embodiments provide that one of the coordinate axes may be set as the reference axis. The reference axis may be used for calculating an angle of the major axis of the bar pattern.

Some embodiments provide that the edge of the bar pattern may be recognized by a typical edge recognizing algorithm. Extracting the coordinates of the edge of the bar pattern may be accomplished by a typical pattern recognizing method. For example, the coordinates of the edge of the bar pattern may be obtained through an image processing method for extracting pixel data with a predetermined intensity (block 220).

The target regions may be set using the coordinates of the edge of the bar pattern (block 230). In more detail, the bar pattern may be divided into two straight portions and two curve portions. Accordingly, the coordinates of the edge of the bar pattern may be fitted into two parallel straight lines in a direction of a central axis of the bar pattern. A portion where the above two straight lines and the coordinates of the edge of the bar pattern are deviated from a predetermined error range may be treated as the curve portion. Accordingly, the bar pattern may be divided into the straight portion and the curve portion. The curve portion may be set in both directions of the central axis of the bar pattern. In some embodiments, the curve portion may be set as the target region.

The outline curve of the bar pattern is extracted by fitting the coordinates of the edge of the bar pattern (block 300). Some embodiments provide that the outline curve may be fitted only in the target regions. Fitting the coordinates of the edge of the bar pattern may remove noise.

The major axis may be determined by differentiating the outline curve with respect to the coordinate axis and connecting points where a differential sign is changed (block 410). The major axis cannot be determined if there are a plurality of points where a differential sign is changed by differentiating the outline curve in each of the target regions. Accordingly, in this case, a point where the differential sign is changed may be set as a point corresponding to the highest point and/or the lowest point of the outline curve. Points where the differential sign is changed that are selected from the target regions are connected to each other to form the major axis.

A major axis angle of the major axis may be an angle between the reference axis and the major axis. The angle of the major axis may be calculated with respect to the reference axis (block 420). The reference axis may correspond to one of the already set coordinate axes. For example, some embodiments provide that the reference axis may be a Y axis in the orthogonal coordinate system.

The image data are rotated to match the major axis with the reference axis using the major axis angle (block 430). In this manner, the image data may be rotated to align the major axis with the reference axis.

It is determined whether the major axis angle is within the predetermined error range or not (block 500). Determining whether the major axis angle may be within the predetermined error range or not may be accomplished by comparing the continuously performed rotation angle of the image data with the predetermined error range.

In some embodiments, detecting the coordinates of the edge of the bar pattern of the rotated image data, extracting the outline curve of the bar pattern by fitting the coordinates of the edge of bar pattern, setting the direction of the major axis by differentiating the outline curve of the bar pattern, and rotating the rotated image data in the direction of the major axis may be repeated. Some embodiments provide that a straight line approximation method may be used for a method of measuring the line width (block 600).

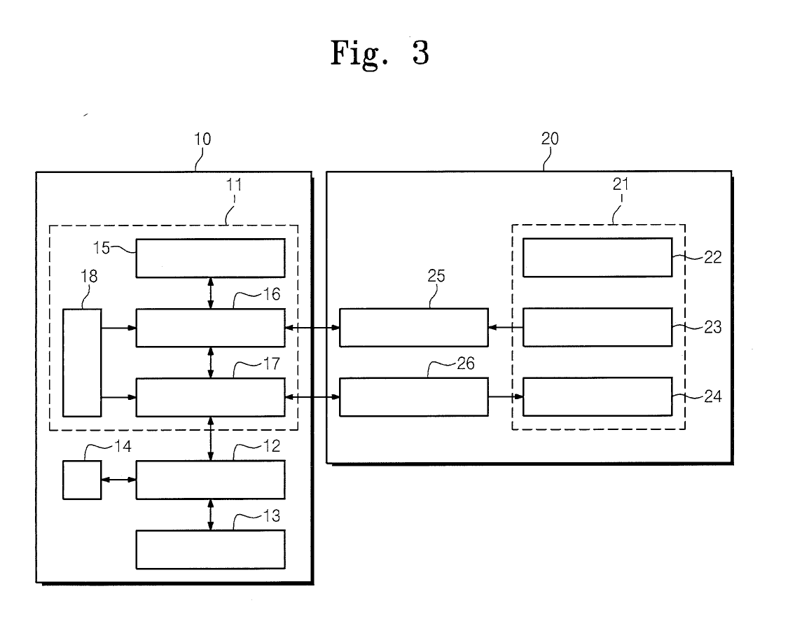

Reference is now made to FIG. 3, which is a view illustrating an image data processing device according to some embodiments of the present invention. A critical dimension scanning electron microscope (CDSEM) device includes an image device 10 and an electron beam device 20. The image device 10 includes a computer 12, an image processing device 11, a memory 14, and an output device 13. The memory 14 may store a recipe file where an algorithm of the image processing method is recorded. The computer 12 may read the recipe file from the memory 14 and may control a device according to the recipe file. The computer 12 may extract information by performing a procedure according to embodiments of the present invention described herein. The output device 13 may display image data, which are supplied from the image processing device 11 to the computer 12.

The image processing device 11 includes a central processing unit (CPU) 18, an image processing unit 17, an image memory control unit 16, and/or an image memory 15, among others. The image processing unit 17 may receive scanning electron microscope (SEM) image data supplied from the CDSEM and may perform an image processing operation on the received SEM image data. The image processing unit 17 may include a unit for obtaining image data with a bar pattern, a unit for detecting coordinates of the edge of the bar pattern, a unit for extracting an outline curve of the bar pattern by fitting the coordinates of the edge of the bar pattern, a unit for setting a direction of a major axis by differentiating the outline curve of the bar pattern and rotating the image data in a direction of a reference axis, and a unit for measuring a line width by processing the bar pattern of the rotated image data. The computer 12 may include a unit for interpreting information of the image processing unit 17.

The electron beam device 20 may include a CDSEM 21, a scan converter 25, and a voltage control unit 26. The CDSEM 21 includes an electron gun unit 22 for emitting an electron beam to a substrate, an electrical optical unit 24 for projecting the electron beam on the substrate by controlling an orbit of the electron beam, and a detecting unit 23 for detecting a secondary electron emitted from the substrate. Information of the detecting unit 23 may be provided to the scan converter 25. Information of the scan converter 25 may be stored in the image memory control unit 16. The voltage control unit 26 may be connected to the image processing unit 17 of the image device 10 and the electrical optical unit 24 of the CDSEM 21. A series of procedures for an image data processing method and a series of procedures for controlling an electron beam device may be stored in a recording medium such as floppy disk or CD-ROM as a program that is executed in a computer, and are executable while the computer reads the recording medium. Accordingly, image data processing methods according to embodiments of the present invention described herein can be realized using general computers. The recording medium may include a magnetic disc, an optical disk, a hard disk, and/or a portable flash memory, among others. In addition, a program including a series of procedures for the image data processing methods may be distributed through a communication circuit such as, for example, the internet. Moreover, a program including a series of procedures for the image data processing method may be stored and/or distributed through a wire/wireless communication circuit such as the internet and/or the recording medium in an encoded, modulated, and/or compressed form.

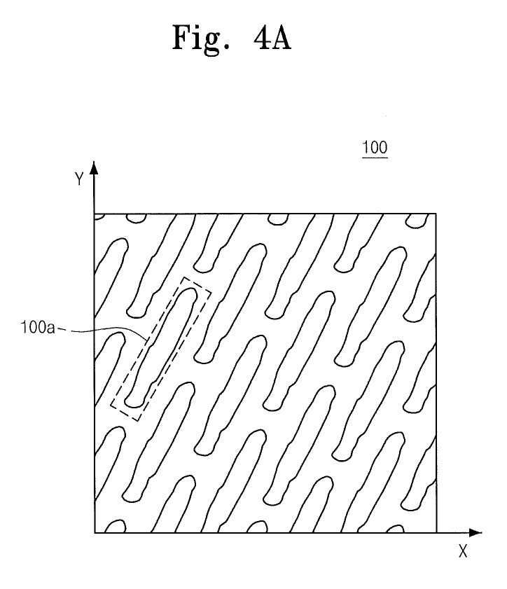

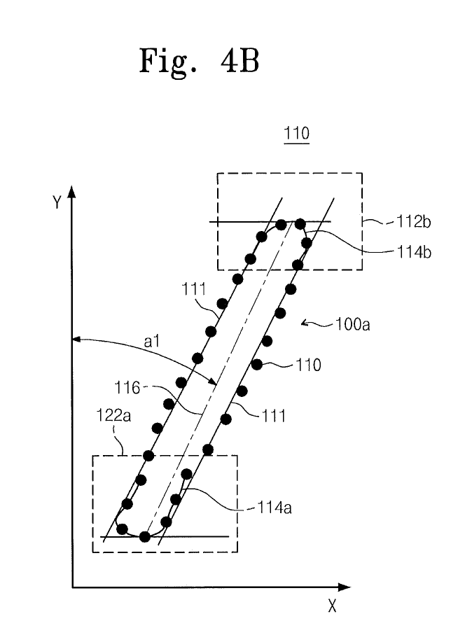

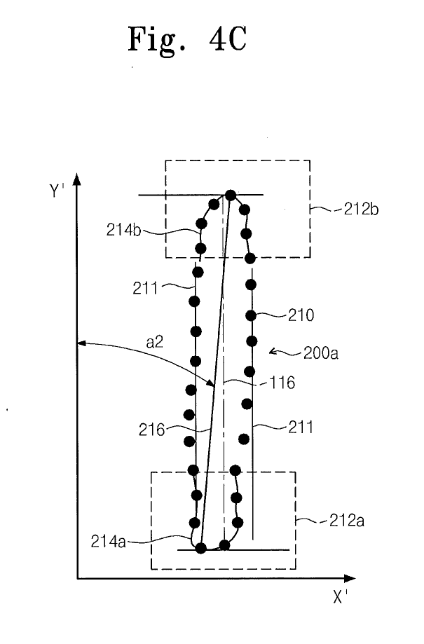

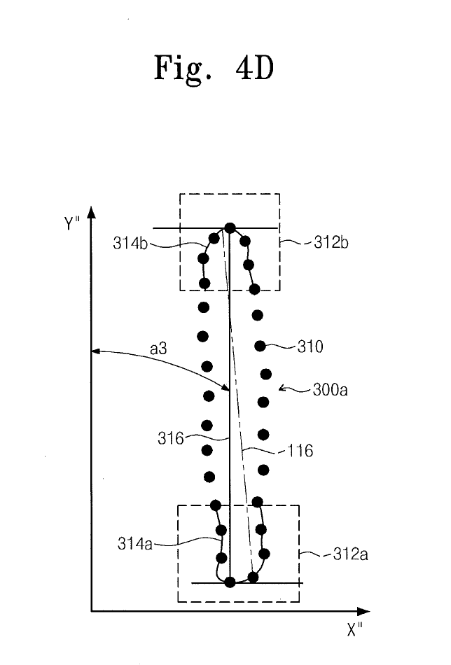

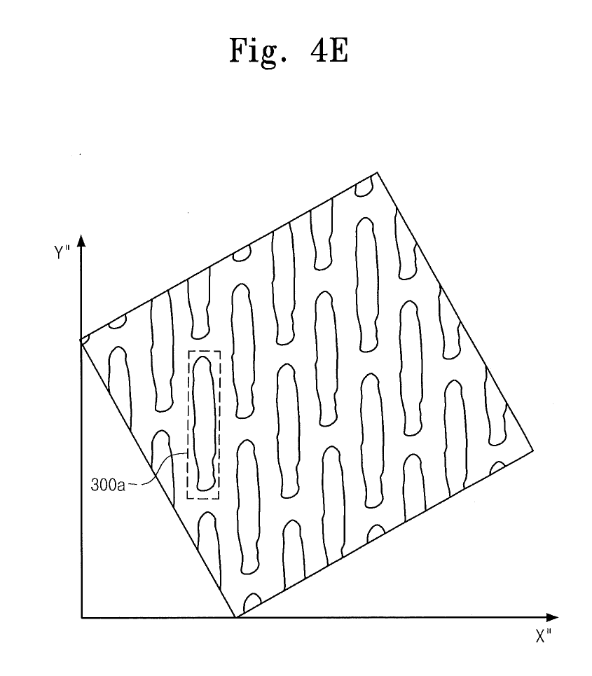

Reference is now made to FIGS. 4A through 4E, which are views illustrating image data processing methods according to some embodiments of the present invention. Image data 100 includes at least one bar pattern 100a. The image data 100 as illustrated are exaggerated for convenience of description. The bar pattern 100a may form a curved loop. In some embodiments, the image data 100 may be provided by the CDSEM. Coordinate axes X and Y of the image data 100 may be set. In some embodiments, the coordinate axis may be axis of an orthogonal coordinate system. The Y-axis may be set as a reference axis.

Referring to FIG. 4B, coordinates 110 of the edge of the bar pattern 100a are extracted by processing the image data 100. The coordinates 110 of the edge of the bar pattern 100a may be set with a position of a pixel. The coordinates 110 of the edge of the bar pattern 100a may be fitted to two straight lines 111 of a direction of a central axis of the bar pattern 100a. A portion where the above two straight lines 111 and the coordinates 110 of the edge of the bar pattern 100a that deviate from a predetermined error range may be treated as a curve portion. Accordingly, the bar pattern 100a may be divided into a straight portion and the curve portion. The curve portion may be set in both ends of the central axis of the bar pattern 100a. The curve portion may be set as target regions 112a and 112b. The target regions 112a and 112b may be set on both ends of the central axis of the bar pattern 100a. The target regions 112a and 112b may not overlap each other. The coordinates 110 of the edge of the bar pattern 100a in the target regions 112a and 112b may be fitted to provide outline curves 114a and 114b. The outline curves 114a and 114b are provided at each of the target regions 112a and 112b. The outline curves 114a and 114b may be differentiated with respect to the X axis, and thus a portion where a differential sign is changed can be calculated. A major axis 116 is set by connecting the points where a differential sign is changed. An angle a1 of the major axis 116 is calculated with respect to the reference axis (i.e., the Y axis).

Referring to FIG. 4C, the image data may be rotated to match the major axis 116 with the reference axis (i.e., the Y axis). New coordinate axes X′ and Y′ of the rotated image data may be set. The Y′ axis and the major axis 116 may be in the same direction. Some embodiments provide that the Y′ axis may be set as a new reference axis.

Using the rotated image data, the coordinates 210 of the edge of the bar pattern 200a may be detected. The coordinates 210 of the edge of the bar pattern 200a are changed using the coordinates 110 of the edge of the bar pattern 100a prior to the rotation. The coordinates 210 of the edge of the bar pattern 200a may be fitted into two straight lines 211 of a central axis direction of the bar pattern 200a. A portion where the two straight lines 211 and the edge coordinates 210 of the edge of the bar pattern 200a deviate from a predetermined error range may be treated as a curve portion. Accordingly, the bar pattern 200a may be divided into a straight portion and a curve portion. The curve portion may be set in both direction of the central axis of the bar pattern 200a. The curve portion may be set as new target regions 212a and 212b. The new target regions 212a and 212b of the bar pattern 200a may be set. Outline curves 214a and 214b of the bar pattern 200a are extracted by fitting the coordinates 210 of the edge of the bar pattern 200a. A direction of a major axis 216 may be set by differentiating the outline curves 214a and 214b of the bar pattern 200a with respect to the X′ axis. An angle a2 of the major axis 216 can be calculated.

Referring to FIG. 4D, the image data may be rotated to match the major axis 216 with the new reference axis Y′. Further new coordinate axes X″ and Y″ of the rotated image data may be set. The Y″ axis and the major axis 216 may be in the same direction. The Y″ axis may be set as a further new reference axis.

Using the rotated image data, the coordinates 310 of the edge of the bar pattern 300a may be detected. The edge coordinates 310 of the edge of the bar pattern 300a are changed using the coordinates 210 of the edge of the bar pattern 200a prior to the rotation. Further new target regions 312a and 312b of the bar pattern 300a may be set. Outline curves 314a and 314b of the bar pattern 300a are extracted by fitting the coordinates 310 of the edge of the bar pattern 300a. A direction of a major axis 316 may be set by differentiating the outline curves 314a and 314b of the bar pattern 300a. An angle a3 of the major axis 316 can be calculated. If the angle a3 of the major axis 316 is within a predetermined range, rotation of the image data may stop.

Referring to FIG. 4E, information of the bar pattern 300a of the image data may be extracted. The information of the bar pattern 300a may include at least one of a line width in the direction of the major axis, a line width in a direction of a minor axis, and an interval between adjacent bar patterns 300a. The line width may be extracted by a straight line approximation method.

The image data processing methods according to some embodiments of the present invention provide accurate line width of a bar pattern using a rotation angle automatic compensation algorithm.

Various embodiments of the present invention are described below with reference to block diagrams illustrating methods, apparatus and computer program products according to various embodiments of the invention. It will be understood that each block of the block diagrams and/or operational illustrations, and combinations of blocks in the block diagrams and/or operational illustrations, can be implemented by analog and/or digital hardware, and/or computer program instructions. These computer program instructions may be provided to a processor of a general purpose computer, special purpose computer, ASIC, and/or other programmable data processing apparatus, such that the instructions, which execute via the processor of the computer and/or other programmable data processing apparatus, create means for implementing the functions/acts specified in the block diagrams and/or operational illustrations. Accordingly, it will be appreciated that the block diagrams and operational illustrations support apparatus, methods and computer program products.

The foregoing is illustrative of the present invention and is not to be construed as limiting thereof. Although a few embodiments of the present invention have been described, those skilled in the art will readily appreciate that many modifications are possible in the embodiments without materially departing from the novel teachings and advantages of the present invention. Accordingly, all such modifications are intended to be included within the scope of the present invention as defined in the claims. Therefore, it is to be understood that the foregoing is illustrative of the present invention and is not to be construed as limited to the embodiments disclosed herein, and that modifications to the disclosed embodiments, as well as other embodiments, are intended to be included within the scope of the appended claims. The present invention is defined by the following claims.

What is claimed is:

1. An image data processing method comprising:
obtaining image data that includes at least one bar pattern;
detecting coordinates of an edge of the at least one bar pattern;
extracting an outline curve of the bar pattern by fitting the coordinates of the edge;
setting a direction of a major axis by differentiating the outline curve of the bar pattern, and rotating the image data to match the major axis with a reference axis; and
extracting information of the bar pattern by processing the bar pattern of the rotated image data.

2. The method of claim 1, wherein detecting the coordinates of the edge of the bar pattern comprises:
setting a coordinate axis of the image data;
extracting the coordinates of the edge of the bar pattern from the image data; and
after dividing the bar pattern into straight line portions and curve portions using the coordinates of the edge of the bar pattern, setting the curve portions as target regions.

3. The method of claim 2, wherein extracting an outline curve of the bar pattern by fitting the coordinates of the edge comprises extracting an outline curve of the bar pattern by fitting the coordinates of the edge only in the target regions.

4. The method of claim 1, wherein setting the direction of the major axis by differentiating the outline curve of the bar pattern and rotating the image data to match the major axis with the reference axis comprise:
determining the major axis by connecting points where a differential sign is changed by differentiating the outline curve;
calculating a major axis angle between the major axis and the reference axis; and
rotating the image data corresponding to the major axis angle.

5. The method of claim 4, further comprising confirming whether the major axis angle is within a predetermined error range or not.

6. The method of claim 1, wherein setting the direction of the major axis by differentiating the outline curve of the bar pattern and rotating the image data to match the major axis with the reference axis comprise:
setting the major axis using the highest point and the lowest point of the outline curve of the bar pattern.

7. The method of claim 1, wherein the information of the bar pattern comprises a line width of the bar pattern or an interval between the bar patterns.

8. The method of claim 1, further comprising repeatedly performing the operations of claim 1.
